(19) United States
(12) Patent Application Publication
(10) Pub. No.: US 2026/0030875 A1
(43) Pub. Date: Jan. 29, 2026

(54) METHOD AND APPARATUS FOR DETECTING LANE LINES

(71) Applicant: Robert Bosch GmbH, Stuttgart (DE)

(72) Inventors: Wanfang Chen, Shanghai (CN); Shu Liu, Shanghai (CN); Kaixuan Zhang, Shanghai (CN); Peng Cui, Shanghai (CN); Jianing Huang, Shanghai (CN)

(21) Appl. No.: 19/270,800

(22) Filed: Jul. 16, 2025

(30) Foreign Application Priority Data
Jul. 25, 2024 (CN) 2024 1100 4352.4

(51) Int. Cl. G06V 10/774; G06V 10/26; G06V 10/40; G06V 10/77; G06V 20/56

(52) U.S. Cl. CPC G06V 10/774; G06V 10/26; G06V 10/40; G06V 10/7715; G06V 20/588

(57) ABSTRACT

A method for training a lane line detection model includes (i) obtaining a dataset comprising a plurality of road image samples, wherein the road image samples have lane line labels, (ii) extracting lane line feature vectors of the road image samples by way of an image segmentation model and the lane line labels of the road image samples, (iii) determining the lane line detection difficulty of the road image samples based on the lane line feature vectors of the road image samples, and (iv) training the lane line detection model using the road image samples in the dataset and a loss function based on the lane line detection difficulty of the road image samples.

This application claims priority under 35 U.S.C. § 119 to application no. CN 2024 1100 4352.4, filed on Jul. 25, 2024 in China, the disclosure of which is incorporated herein by reference in its entirety.

The present disclosure generally relates to assisted driving and autonomous driving technologies for vehicles, and more specifically, to lane line detection technologies for vehicle roadways.

### BACKGROUND

Intelligent driving technologies such as vehicle assisted driving and autonomous driving are currently developing at a rapid pace. During the process of driving on the road, intelligent vehicles need to recognize lane lines. Lane lines are traffic markings used to divide the roadway in a traffic environment, thereby assisting vehicles to travel safely and efficiently on the road. Lane line detection is a technology that automatically detects lane lines on the road based on the perception of the traffic environment. Lane line detection is an important component of intelligent driving technology. For example, functions such as adaptive cruise control, lane keeping, and lane departure warning in advanced driver assistance systems (ADAS) all rely on lane line detection technology. The accuracy and reliability of lane line detection will also directly affect the safety of intelligent vehicle driving.

Traditional lane line detection methods mainly include detecting yellow and white lane lines through color thresholding, detecting straight lane lines through edge detection combined with Hough transform, or fitting lane lines using algorithms such as Random Sample Consensus (RANSAC). Traditional lane line detection methods suffer from disadvantages such as poor robustness and stability. With the continuous development of artificial intelligence technologies, especially deep learning algorithms, various network models for lane line detection have emerged. Although deep learning-based lane line detection models exhibit better generalization and adaptability compared to traditional methods, due to the complexity of road environments, lane line detection models may make errors in certain road scenarios, thereby posing potential safety hazards to traffic.

Therefore, there is a need to improve methods for detecting lane lines based on lane line detection models, so as to enhance the accuracy and reliability of lane line detection.

### SUMMARY

A brief description of one or more aspects according to the present disclosure is provided below in order to provide a basic understanding of these aspects. The present disclosure is not a broad overview of all aspects, nor is it intended to identify the key elements of all aspects or delineate the scope of any or all aspects. The sole purpose thereof is to present certain concepts of one or more aspects in a simplified form as a prelude to the more detailed description that follows.

According to one aspect of the present disclosure, a method for training a lane line detection model may comprise: obtaining a dataset comprising a plurality of road image samples, wherein the road image samples have lane line labels; extracting lane line feature vectors of the road image samples by way of an image segmentation model and the lane line labels of the road image samples; determining the lane line detection difficulty of the road image samples based on the lane line feature vectors of the road image samples; and training the lane line detection model using the road image samples in the dataset and a loss function based on the lane line detection difficulty of the road image samples.

According to one aspect of the present disclosure, an apparatus for training a lane line detection model may comprise a memory and at least one processor coupled to the memory. The processor may be configured to obtain a dataset comprising a plurality of road image samples, wherein the road image samples have lane line labels; extract lane line feature vectors of the road image samples by way of an image segmentation model and the lane line labels of the road image samples; determine the lane line detection difficulty of the road image samples based on the lane line feature vectors of the road image samples; and train the lane line detection model using the road image samples in the dataset and a loss function based on the lane line detection difficulty of the road image samples.

According to one aspect of the present disclosure, a computer program product for training a lane line detection model may comprise computer program code executable by a processor. The computer program code may be configured to obtain a dataset comprising a plurality of road image samples, wherein the road image samples have lane line labels; extract lane line feature vectors of the road image samples by way of an image segmentation model and the lane line labels of the road image samples; determine the lane line detection difficulty of the road image samples based on the lane line feature vectors of the road image samples; and train the lane line detection model using the road image samples in the dataset and a loss function based on the lane line detection difficulty of the road image samples.

According to one aspect of the present disclosure, a method for detecting lane lines may comprise receiving a road image; and detecting lane lines in the received road image by way of a lane line detection model. The lane line detection model is trained using the lane line detection model training method of the present disclosure, employing a loss function based on the lane line detection difficulty of road image samples in the training dataset.

According to one aspect of the present disclosure, an apparatus for detecting lane lines may comprise a memory and at least one processor coupled to the memory. The processor may be configured to receive a road image; and detect lane lines in the received road image by way of a lane line detection model. The lane line detection model is trained using the lane line detection model training method of the present disclosure, employing a loss function based on the lane line detection difficulty of road image samples in the training dataset.

According to one aspect of the present disclosure, a computer program product for training a lane line detection model may comprise computer program code executable by a processor. The computer program code may be used to receive a road image; and detect lane lines in the received road image by way of a lane line detection model. The lane line detection model is trained using the lane line detection model training method of the present disclosure, employing a loss function based on the lane line detection difficulty of road image samples in the training dataset.

It should be noted that the above one or more aspects include the following detailed description and features that are specifically recorded in the patent claims. The following specification and accompanying drawings detail some of the exemplary features from a variety of aspects. These features merely indicate a variety of ways in which the principles of various aspects may be implemented, and the present disclosure is intended to include all of these aspects and their equivalents.

### BRIEF DESCRIPTION OF THE DRAWINGS

The following drawings describe various examples of the present disclosure for illustrative purposes only. Those skilled in the art will readily recognize from the following description that alternative examples of the methods and structures disclosed herein may be achieved without departing from the spirit and principles disclosed herein.

FIG. 1 illustrates a schematic diagram of the network architecture of a lane line detection model according to one embodiment of the present disclosure.

FIG. 2 illustrates a schematic diagram of road images with different lane line detection difficulties according to one embodiment of the present disclosure.

FIG. 3 illustrates a flowchart of a method for training a lane line detection model according to one embodiment of the present disclosure.

FIG. 4 illustrates a schematic diagram of the structure of a Segment Anything Model for guiding the training of a lane line detection model according to one embodiment of the present disclosure.

FIG. 5 illustrates a schematic diagram of the process for extracting lane line feature vectors from road image samples according to one embodiment of the present disclosure.

FIG. 6 illustrates a flowchart of a method for detecting lane lines according to an embodiment of the present disclosure.

FIG. 7 illustrates a block diagram of an apparatus for training a lane line detection model or detecting lane lines according to an embodiment of the present disclosure.

### DETAILED DESCRIPTION

In the following description, numerous specific details are set forth to provide a thorough understanding of the examples of the present disclosure. However, those skilled in the relevant art will recognize that the present disclosure can be practiced without one or more of the specific details, or by using alternative methods, components, etc., to practice the present disclosure. In some instances, well-known structures and operations are not shown or described in detail to avoid unnecessarily obscuring the present disclosure.

A lane line detection model is a network model used to predict lane lines in input road images. Lane line detection can be considered a specific task within the field of computer vision in artificial intelligence, such as semantic segmentation or instance segmentation. Both semantic segmentation and instance segmentation fall under the category of image segmentation tasks, which assign a semantic or instance label to each pixel in an image. The lane line detection model may utilize commonly used image segmentation models in computer vision, such as Convolutional Neural Networks (CNNs), Mask Region-based Convolutional Neural Networks (Mask R-CNN), and the like. In view of the characteristics of road images and lane lines, certain network models specifically designed for lane line detection have also been proposed, such as the Spatial Convolutional Neural Network model (see “Spatial As Deep: Spatial CNN for Traffic Scene Understanding”), the Recurrent Feature-Shift Aggregator model (see “RESA: Recurrent Feature—Shift Aggregator for Lane Detection”), and the Cross Layer Refinement Network model (see “CLRNet: Cross Layer Refinement Network for Lane Detection”), among others.

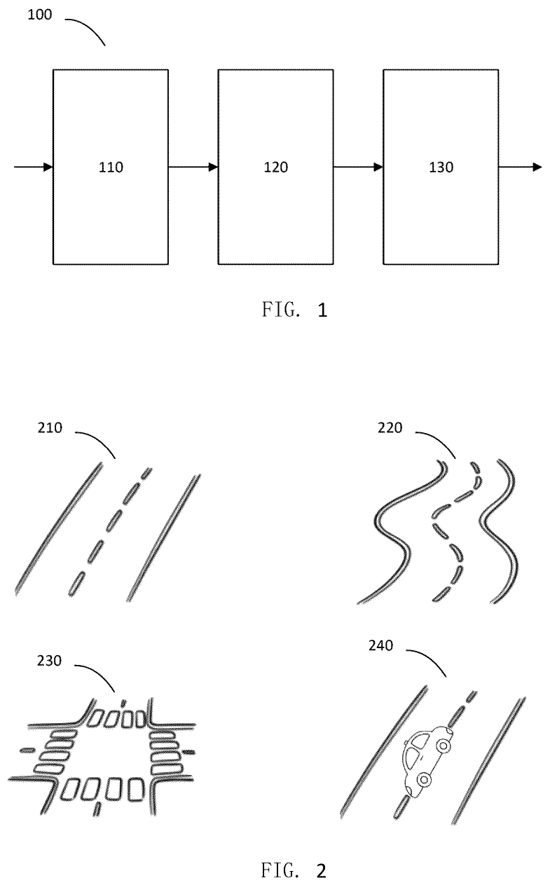

FIG. 1 illustrates a schematic diagram of the network architecture of a lane line detection model according to one embodiment of the present disclosure. The lane line detection model 100 may have the same network architecture as the CNN-based recurrent feature-shift aggregation (RESA) model. The lane line detection model 100 may include an encoder module 110, a recurrent feature-shift aggregation module 120, and a decoder module 130. As shown in FIG. 1, a road image may first be input into the encoder module 110. The encoder module 110 may be used to extract semantic information from the input road image and convert it into a feature map. The encoder module 110 may employ various commonly used networks, such as CNNs (Convolutional Neural Networks), VGG (Visual Geometry Group) networks, ResNet (Residual Networks), and so on. The encoder module 110 may reduce the size of the input road image, for example, reducing the image to ⅛ of its original size.

The recurrent feature-shift aggregation module 120 is a newly added module in the RESA model, which may be used to extract spatial features from the road image. The recurrent feature-shift aggregation module 120 may extract spatial features by cyclically shifting the feature map obtained from the encoder module 110 in four directions-top to bottom, bottom to top, left to right, and right to left-during each iteration of the model training phase. Through multiple iterations, each position in the feature map can receive information from the entire feature map. Extracting spatial information is very helpful for detecting objects with strong spatial relationships and continuous elongated shapes, such as lane lines. By utilizing the recurrent feature-shift aggregation module 120 to obtain spatial information from the road image, the performance of the lane line detection model can be improved.

The decoder module 130 may upsample the feature map output by the recurrent feature-shift aggregation module 120 to restore the low-dimensional feature map to the original size of the input road image and perform pixel-level prediction. In one embodiment, the decoder module 130 may include bilateral upsampling blocks. Each block may perform two upsampling operations, ultimately restoring the ⅛-sized feature map to its original size. The decoder module 130 may include a fully connected layer to obtain a probability distribution prediction of the lane line based on the output of the upsampling block and to perform binary classification for each pixel (i.e., whether the pixel is a lane line pixel).

FIG. 1 is merely an example of a model network architecture that can be used to perform the lane line detection task. The lane line detection model training method and lane line detection method disclosed herein are not limited to the specific structure of the lane line detection model and may be applicable to other existing or future model network architectures suitable for lane line detection, beyond the model shown in FIG. 1.

Before using the lane line detection model to detect lane lines on a road, the model needs to be trained using a dataset comprising a large number of road image samples. The road image samples in the training dataset include lane line labels, i.e., ground truth values for each sample. The training process for the lane line detection model is similar to general model training processes and mainly includes inputting road images into the lane line detection model, comparing the predicted lane line values output by the model with the ground truth values of the samples (e.g., calculating the difference between the predicted and ground truth values according to a loss function), and adjusting the parameters of the lane line detection model based on the comparison results. The above training process may be repeated in the training dataset until the similarity between the predicted values output by the lane line detection model and the ground truth values of the samples meets the requirements.

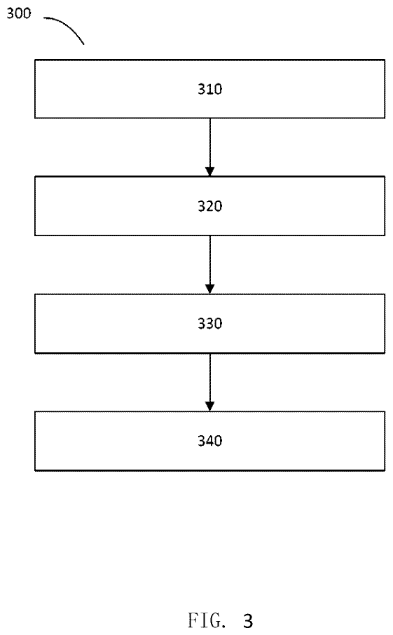

The road traffic environments that the lane line detection model needs to handle are often very complex. To broaden the applicability of the lane line detection model, the training dataset may include road image samples covering various scenarios. These road image samples may have different levels of lane line detection difficulty depending on the traffic environment and road conditions. FIG. 2 illustrates a schematic diagram of road images with different lane line detection difficulties according to one embodiment of the present disclosure. Road image schematic 210 includes straight lane lines, which are relatively easy to detect. Road image schematic 220 includes S-shaped curved lane lines, which are relatively difficult to detect. In addition to S-shaped lane lines, lane lines may also be other non-linear types, such as merging or diverging forked lanes, whose detection difficulty is also higher than that of conventional straight lanes. Road image schematic 230 includes a zebra crossing, whose shape and color are similar to lane lines and thus are easily misidentified as lane lines. In road image schematic 240, the lane lines are occluded by vehicles, thereby increasing the difficulty of lane line detection. Although the road image schematics shown in FIG. 2 only include roads, actual road images may also include various buildings, pedestrians, trees, and traffic facilities such as road signs, traffic lights, roadblocks, medians, etc. In addition to the factors affecting lane line detection difficulty shown in FIG. 2, factors such as lighting conditions of the road image, lane density, and even the absence of marked lane lines on some rural roads may also result in road images with varying degrees of lane line detection difficulty. The road image samples in the training dataset typically include lane line labels, such as pixel-level labels or keypoint labels. Pixel-level labels can mark the pixels in the road image corresponding to lane lines.

For example, pixel-level labels may mark pixels in a road image as “1” (indicating that the probability of the pixel corresponding to a lane line is 100%, i.e., the pixel is a lane line), or as “0” (indicating that the probability of the pixel corresponding to a lane line is 0%, i.e., the pixel is a non-lane line). Keypoint labels may mark the keypoint positions of lane lines in the road image, and pixels within a threshold range of these keypoints correspond to lane lines. Therefore, keypoint labels may be converted into pixel-level labels. Regardless of whether pixel-level labels or keypoint labels are used, the lane line labels of road image samples deterministically mark the lane lines in the road image, but cannot indicate the detection difficulty of the lane lines in the road image samples. In other words, the road image samples do not include information about the lane line detection difficulty of the road image sample.

Accordingly, when training a lane line detection model using road image samples from such a training dataset, the varying detection difficulties of different samples are generally not taken into account.

For example, the objective function or loss function used in conventional lane line detection model training methods typically aims to minimize the difference (e.g., relative entropy or cross-entropy) between the model's predicted distribution and the ground truth distribution, regardless of the detection difficulty of lane lines in different road image samples. That is, during the training process of the lane line detection model, the model parameters are adjusted in the same way for both samples with high lane line detection difficulty and those with low difficulty, so as to make the predicted probability distribution of lane lines as close as possible to the ground truth, e.g., even for samples with high detection difficulty, the model is still expected to predict the lane line probability close to 100%. Such a training method may lead to problems of overfitting and overconfidence in the lane line detection model. An overfitted and overconfident lane line detection model may provide incorrect or unreliable lane line predictions for downstream intelligent driving tasks. In particular, for road environments with high lane line detection difficulty, such as abnormal lane markings, the lane line detection model trained by existing methods may output poor prediction results. This may cause the intelligent driving function to make inappropriate decisions, such as the vehicle deviating from the lane, thereby posing traffic safety risks or even causing accidents.

Therefore, the lane line detection model training method provided in this disclosure quantifies the lane line detection difficulty of each road image sample in the training dataset, and trains the lane line detection model using the training dataset while taking into account the difficulty of each sample. The lane line detection model trained by the method disclosed herein can have more reliable performance during actual inference, and the prediction results for road images with different lane line detection difficulties can have different levels of uncertainty. This allows downstream intelligent driving functions to make reasonable decisions and operations based on both the predicted results and the corresponding uncertainty from the lane line detection model, thereby improving the reliability and safety of intelligent driving functions.

FIG. 3 illustrates a flowchart of a method 300 for training a lane line detection model according to one embodiment of the present disclosure. The lane line detection model training method 300 may be executed by a computing device such as a cloud server, edge computing platform, or in-vehicle computer. The method 300 may be used to train a lane line detection model with the network architecture described in conjunction with FIG. 1, or with other network architectures. Although certain steps of method 300 are exemplarily described below in conjunction with the network architecture of the lane line detection model in FIG. 1, method 300 is not limited to any specific lane line detection model structure.

In step 310, method 300 may first obtain a dataset comprising multiple road image samples. The road image samples in the dataset may have lane line labels. Method 300 may obtain this dataset from a third party, such as the CULane dataset. Alternatively, method 300 may obtain the training dataset by receiving road images captured by vehicle-mounted sensors (e.g., cameras) during driving in various traffic scenarios, and annotating the received road images with lane lines. The road images may be individual video frames from road videos recorded by in-vehicle cameras. Lane line labels can be added to the received road images either manually or using existing annotation tools. Method 300 may obtain the lane line detection model training dataset from local storage, or download it from a remote server via a network and store it locally for subsequent operations.

In step 320, method 300 may extract lane line feature vectors of the road image samples using an image segmentation model and the lane line labels of the road image samples. The image segmentation model may be a commonly used semantic segmentation or instance segmentation model in computer vision, and may be pre-trained to segment lane lines in road images. The image segmentation model is used to guide the training of the lane line detection model and is different from the lane line detection model being trained. The image segmentation model here can segment the actually visible lane markings in the road image, while the lane line detection model can predict occluded lane lines as well as lane lines on roads where no actual lane lines are painted.

With the rapid development of current artificial intelligence technology, many high-performance large models have emerged. Large models, also known as foundation models, refer to machine learning models with large-scale parameters and complex computational structures, capable of handling various complex tasks including computer vision. Large models are trained on massive datasets to learn complex features, have stronger generalization capabilities, and can make accurate predictions on unseen data. In one embodiment, the image segmentation model used in step 320 to guide the training of the lane line detection model may directly use a pre-trained foundation model capable of performing image segmentation tasks, such as the Segment Anything Model (SAM).

SAM is a foundation model for image segmentation, pre-trained on more than 10 million images and over 1 billion masks, and has demonstrated remarkable performance in the field of computer vision. FIG. 4 illustrates a schematic diagram of the structure of a SAM 400 for guiding the training of a lane line detection model according to one embodiment of the present disclosure. SAM 400 mainly includes an image encoder module 410, a prompt encoder module 420, a mask decoder module 430, a convolution module 440, and an output layer 450. The image encoder module 410 may be used to resize and convolve the input high-resolution image to extract image features (i.e., image embeddings). The convolution module 440 may convolve the input mask prompts, add the output to the output of the image encoder module 410, and input the result to the mask decoder module 430. The prompt encoder module 420 may encode input points, boxes, or text prompts, and input the resulting prompt embeddings to the mask decoder module 430. The mask decoder module 430 may map the image embeddings and prompt embeddings to masks, and input them to the output layer 450. The output layer 450 may post-process the multiple predicted mask images to output the final prediction results.

Method 300 may input the road image samples from the dataset obtained in step 310 into the above-mentioned image segmentation model, and extract the feature map output from an intermediate layer (for example, the penultimate layer) of the image segmentation model. In one embodiment, the image segmentation model may be a pre-trained base model such as SAM, and accordingly, the intermediate layer of the image segmentation model may be the last layer of the image encoder in SAM or the last layer of the mask decoder in SAM (i.e., the penultimate layer of SAM). Method 300 may adjust the dimensions of the road image samples according to the dimensions of the feature map output from the intermediate layer of the image segmentation model. Then, method 300 may extract the lane line feature vector of the road image sample based on the feature map output from the intermediate layer of the image segmentation model and the lane line label of the road image sample, which has a dimension corresponding to the feature map. The lane line feature vector is a feature vector associated with the labeled lane line in the road image sample, including the feature vectors of pixels labeled as lane lines by the lane line label in the road image sample and the feature vectors of their neighboring pixels. The lane line feature vector is based on the feature map output from the intermediate layer of the image segmentation model when the road image sample is used as input.

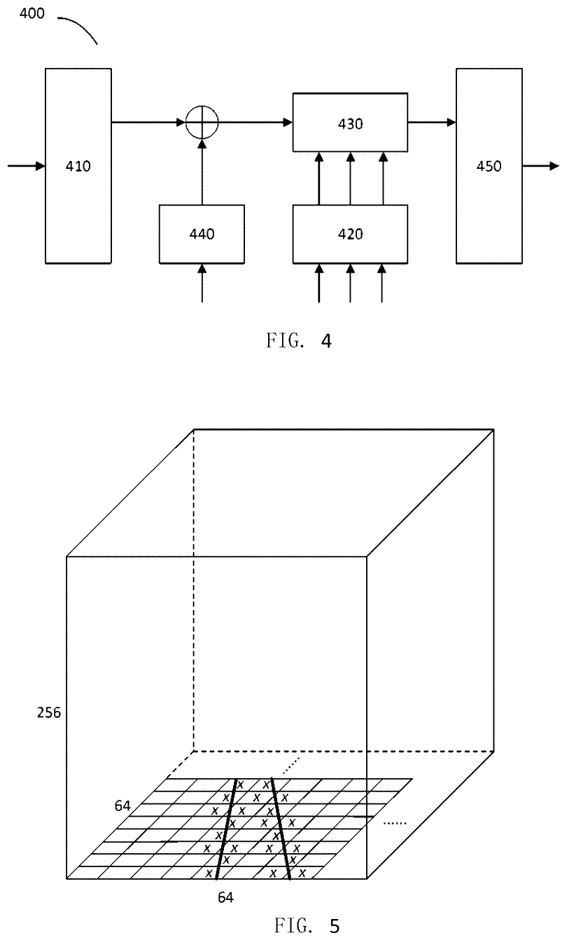

FIG. 5 illustrates a schematic diagram of the process for extracting lane line feature vectors from road image samples according to one embodiment of the present disclosure. In this embodiment, the lane line feature vector of the road image sample is extracted based on the feature map output from the penultimate layer of SAM. As shown in FIG. 5, the dimension of the feature map obtained when SAM processes the input road image sample up to the penultimate layer is 64*64*256, where the 64*64 dimension corresponds to resizing the original size of the input road image sample (e.g., reducing it) to a 64*64 grid through convolution and other processing, and each grid cell contains a 256*1 feature vector. To map the lane line label of the road image sample to the feature map with a dimension of 64*64*256, the original size of the road image sample may be resized to 64*64, and the resized road image sample is overlaid onto the 64*64 plane of the feature map output from the penultimate layer of SAM, as shown by the bottom face of the cube in FIG. 5. Next, the 256*1 feature vectors in the grid cells traversed by the lane line labeled by the lane line label may be extracted. The lane line label marks the pixels in the road image sample that belong to the lane line. As shown by the “x” in FIG. 5, the extracted grid cells contain the pixels labeled as lane lines as well as their neighboring pixels (e.g., pixels in the same grid cell). Finally, the multiple (e.g., N, where N is a positive integer) 256*1 feature vectors from the extracted grid cells may be averaged, for example, by summing the N 256*1 feature vectors and dividing by N, thereby obtaining a single 256*1 feature vector as the lane line feature vector of the road image sample.

This lane line feature vector is based on the features extracted by the intermediate layer of the image segmentation model for the road image sample, and is only related to the features of the pixels labeled as lane lines and their neighboring pixels in the road image sample. In addition to the method shown in FIG. 5, other methods may also be used to extract the feature vectors associated with the lane lines labeled in the road image sample from the feature map output from the intermediate layer of the image segmentation model for the input road image sample.

In step 330, method 300 may determine the lane line detection difficulty of the road image sample based on the extracted lane line feature vector of the road image sample. Various different metrics may be used to quantify the lane line detection difficulty of the road image sample based on the lane line feature vector.

In one embodiment, the lane line detection difficulty of each sample in the multiple road image samples may be determined by calculating the Mahalanobis distance from each lane line feature vector (extracted from multiple road image samples in the dataset) to the distribution of these lane line feature vectors. The multiple lane line feature vectors extracted in step 320 for the multiple road image samples in the dataset can be fitted to a multivariate Gaussian distribution, and based on the obtained multivariate Gaussian distribution, the Mahalanobis distance for each road image sample can be calculated. This Mahalanobis distance can be used to measure the lane line detection difficulty of each road image sample. Depending on the distribution characteristics of the lane line feature vectors, they may also be fitted to other appropriate distribution functions.

The expression for the “multivariate Gaussian distribution” is as follows:

$$( x \vert μ , Σ ) = \frac{1}{{( 2 π )}^{D / 2}} \frac{1}{{\vert Σ \vert}^{1 / 2}} exp \{ - \frac{1}{2} {( x - μ )}^{T} {Σ}^{- 1} ( x - μ ) \} \qquad ( 1 )$$

Where χ represents the data variable, such as the lane line feature vector, D represents the dimension of the variable χ (e.g., 256), μ represents the mean of the multivariate Gaussian distribution of the multiple lane line feature vectors, and S represents the D*D covariance matrix of the multivariate Gaussian distribution, defined as S=E[(χ−μ) (χ−μ)^{T}].

After obtaining the expression of the multivariate Gaussian distribution of the multiple lane line feature vectors, the Mahalanobis distance DM between the lane line feature vector of each road image sample and the mean of the multivariate Gaussian distribution can be calculated as follows:

$${D}_{M} ( x ) = \sqrt{{( x - μ )}^{T} {Σ}^{- 1} ( x - μ )} \qquad ( 2 )$$

Where X represents the lane line feature vector, μ represents the mean of the multivariate Gaussian distribution, and S represents the covariance matrix of the multivariate Gaussian distribution.

Since in this embodiment, most of the road image samples in the dataset reflect normal road conditions with relatively low lane line detection difficulty, and a small portion reflect abnormal road conditions with relatively high lane line detection difficulty, the Mahalanobis distance between the lane line feature vector of the road image sample and the mean of the lane line feature vectors in the training set may be used to measure the lane line detection difficulty of the road image sample. The Mahalanobis distance is a modification of the Euclidean distance, correcting for the inconsistency of scales and correlations between dimensions in the Euclidean distance.

In step 340, method 300 may use the road image samples in the dataset and a loss function based on the lane line detection difficulty of the road image samples to train the lane line detection model. The training process of the lane line detection model includes, in each iteration, inputting the dataset or a batch of road image samples into the lane line detection model, the model outputs a prediction value through forward propagation, then the loss function is used to calculate the difference (i.e., loss value) between the prediction value (predicted distribution) and the ground truth value (ground truth distribution). After obtaining the loss value, the model updates its parameters through backpropagation to reduce the gap between the predicted value and the ground truth value, thereby achieving the purpose of model learning.

The loss function used in the training process of the lane line detection model may include a loss term representing the difference between the predicted value and the ground truth value, and a regularization term based on the lane line detection difficulty of the road image sample. The loss term in the loss function can be a relative entropy loss, cross-entropy loss, focal loss, etc. Relative entropy loss, also known as KL divergence, may represent the difference between the information entropy of the predicted probability distribution and the information entropy of the true probability distribution. Information entropy may be interpreted as the expected value of the information content of various probability outputs. Cross-entropy loss is a variant of relative entropy loss with the information entropy of the true probability distribution omitted. Since the true probability distribution and its information entropy for each labeled road image sample are fixed, this term can be ignored when calculating the loss. Focal loss is an improvement over cross-entropy loss; it is a dynamically scaled cross-entropy loss used to address the problem of imbalance between positive and negative samples.

The regularization term in the loss function may be an entropy regularization term with a weighting coefficient proportional to the lane line detection difficulty of the road image sample. This weighting coefficient is determined based on the lane line detection difficulty of each road image sample and varies with the input road image sample. Therefore, through this entropy regularization term, the loss function may be penalized to different extents according to the varying difficulty of road image samples, enabling the lane line detection model to provide predictions with different levels of uncertainty for inputs with different detection difficulties. The higher the detection difficulty, the greater the uncertainty of the prediction, i.e., the model's confidence in the lane line prediction for more difficult input road images is reduced. In this way, downstream tasks may make reasonable use of the model's predictions based on the uncertainty of the lane line detection model's output, thereby improving the reliability of the lane line detection model. The entropy regularization term may also have a global weighting coefficient to control its strength within the loss function.

In one embodiment, a loss function as shown in Equation (3) below may be used to train the lane line detection model:

$$ℓ = E \{ - log ( {f}_{θ} ( {x}_{i} ) [ {y}_{i} ] - α s ( {x}_{i} ) ℋ [ {f}_{θ} ( {x}_{i} ) ] \} \qquad ( 3 )$$

where −log (f_{θ}(xᵢ)[yᵢ]) is the loss term in the loss function, yᵢ denotes a pixel in the road image sample in the dataset, denotes the ground truth value of the lane line label for the road image sample (for lane line pixels yᵢ=1, for non-lane line pixels yᵢ=0), θ denotes the parameters of the lane line detection model, f_{θ}(xᵢ) denotes the predicted value for the corresponding pixel in the road image sample by the lane line detection model, and f_{θ}(xᵢ)[yᵢ] denotes the probability that the model predicts the pixel as a lane line. −(αs(xᵢ)) [symbol] [f_{θ}(xᵢ)] is the entropy regularization term in the loss function, [symbol] [f_{θ}(xᵢ)] denotes the information entropy of the predicted probability distribution for the road image sample, α is a hyperparameter to control the global strength of the entropy regularization term, and its value may be in the range (0, 0.5). s(xᵢ) is a sample-specific weighting coefficient normalized based on the lane line detection difficulty (e.g., Mahalanobis distance D(xᵢ) of the road image sample, and its value may be in the range (0, 1). Since lane line detection difficulty is defined for the road image sample, s(xᵢ) is the same for all pixels in a given road image sample. In one embodiment, s(xᵢ) may be as shown in Equation 4 below, where parameter c is a small constant (e.g., 1e-3) to ensure s(xᵢ) falls within the range (0, 1), and T is an adjustable parameter to control the relative importance among all training data.

$$s ( {x}_{i} ) = \frac{exp ( D ( {x}_{i} ) / T )}{{max}_{i} \{ exp ( D ( {x}_{i} ) / T \} + c} \qquad ( 4 )$$

The lane line detection model may be trained iteratively using road image samples from the dataset or in batches. When the loss function of the model's prediction falls below a predetermined threshold or meets a predetermined convergence condition, the training process for the lane line detection model may be completed, and the trained model may be used to detect or predict lane lines in actual road images.

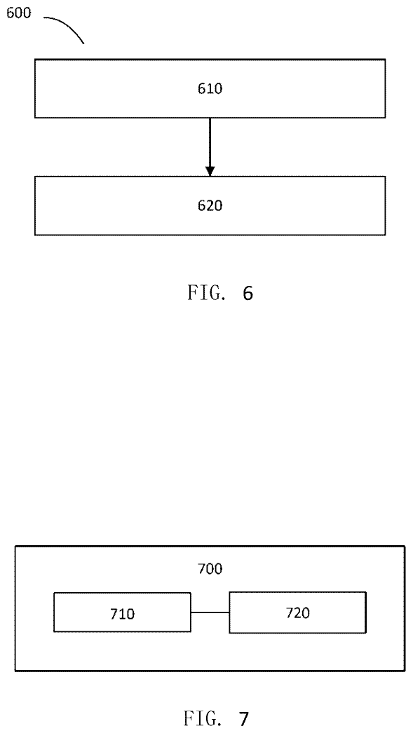

FIG. 6 illustrates a flowchart of a method 600 for detecting lane lines according to an embodiment of the present disclosure. Method 600 may be executed by an intelligent driving control system of a vehicle. At step 610, method 600 can receive road images captured in real time during vehicle driving from onboard sensors (e.g., cameras). The road images may be individual frames from a video captured by the camera. The road images may have different resolutions or formats, and various image processing techniques can be used to convert the received road images into input images of the resolution or format required by the lane line detection model.

At step 620, method 600 may detect lane lines in the received road images using the lane line detection model. Detecting lane lines in road images includes both identifying lane line traffic markings such as solid or dashed lines on the road, and predicting lane lines on roads without lane line markings. The lane line detection model used for detection is trained using a loss function based on the lane line detection difficulty of road image samples in the training dataset. For example, the lane line detection model may be trained by combining the method 300 described in FIG. 3. Since a loss function not used in existing lane line detection model training methods is adopted for training, the lane line detection model used in method 600 has model parameters different from those of existing lane line detection models. Because the lane line detection model used in method 600 may output predictions with different uncertainties for road images with different lane line detection difficulties (e.g., providing higher uncertainty for more difficult road images), method 600 may provide more reliable lane line detection results and reduce the occurrence of overconfident erroneous detections.

FIG. 7 illustrates a block diagram of an apparatus 700 for training a lane line detection model or detecting lane lines according to an embodiment of the present disclosure. As shown in FIG. 7, apparatus 700 may include a memory 710 and at least one processor 720 coupled to the memory 710.

In one embodiment, apparatus 700 may be a device for training a lane line detection model, such as a cloud server with strong computing power, an edge computing platform, or even an onboard computer. Processor 720 may be configured to execute the lane line detection model training method described above in connection with FIG. 3. For example, the processor 720 may be configured to obtain a dataset comprising a plurality of road image samples, wherein the road image samples have lane line labels; extract lane line feature vectors of the road image samples by way of an image segmentation model and the lane line labels of the road image samples; determine the lane line detection difficulty of the road image samples based on the lane line feature vectors of the road image samples; and train the lane line detection model using the road image samples in the dataset and a loss function based on the lane line detection difficulty of the road image samples. Memory 710 may be configured to store the training dataset and parameters of the trained lane line detection model, among other things.

In another embodiment, apparatus 700 may be a device for detecting lane lines, such as an intelligent driving vehicle or an intelligent driving control system within such a vehicle. Processor 720 may be configured to execute the lane line detection method described above in connection with FIG. 6. For example, the processor 720 may be configured to receive a road image; and detect lane lines in the received road image by way of a lane line detection model. The lane line detection model is trained using a loss function based on the lane line detection difficulty of road image samples in the training dataset. The lane line detection model may be stored in the local memory 710, or it may be stored on an edge computing platform or a cloud server capable of communicating with the apparatus 700.

The processor 720 shown in FIG. 7 may be a general-purpose processor, or may be implemented as a combination of computing devices, such as one or more of a digital signal processor (DSP), central processing unit (CPU), graphics processing unit (GPU), and neural processing unit (NPU), among others. The memory 710 may include non-volatile memory for storing computer program code implementing the methods disclosed herein, as well as parameters of the lane line detection model. The memory 710 may further include volatile cache memory for temporarily storing data received during processor execution (for example, road images) and data obtained after processing (for example, detection results), among others.

The various operations described in conjunction with this disclosure may be performed with hardware, software executed by a processor, firmware, or any combination thereof. In one embodiment, the present disclosure provides a computer program product for training a lane line detection model, which may include processor-executable computer program code for performing the method described above in connection with FIG. 3. In one embodiment, the present disclosure provides a computer program product for detecting lane lines, which may include processor-executable computer program code for performing the method described above in connection with FIG. 6. In another embodiment, the present disclosure further provides a computer-readable medium, which may store the above-mentioned computer program code. When executed by a processor, the computer program code may cause the processor to perform the methods described above in connection with FIG. 3 and/or FIG. 6. Computer-readable media include both non-transitory computer storage media and communication media. Communication media include any medium that facilitates the transfer of a computer program from one place to another. Any connection may be appropriately referred to as a computer-readable medium. Other examples and implementations are within the scope of the present disclosure.

In addition to the content described in this document, various modifications can be made to the disclosed examples and implementations of the present disclosure without departing from the scope of the disclosed examples and examples of the present disclosure. Therefore, the description and examples herein should be interpreted as illustrative and not restrictive. The scope of the present disclosure should only be determined by reference to the patent claims.

What is claimed is:

1. A method for training a lane line detection model, comprising:
obtaining a dataset comprising a plurality of road image samples, wherein the road image samples have lane line labels;
extracting lane line feature vectors of the road image samples by way of an image segmentation model and the lane line labels of the road image samples;
determining the lane line detection difficulty of the road image samples based on the lane line feature vectors of the road image samples; and
training the lane line detection model using the road image samples in the dataset and a loss function based on the lane line detection difficulty of the road image samples.

2. The method according to claim 1, wherein the image segmentation model comprises a pre-trained base model for image segmentation.

3. The method according to claim 1, wherein the lane line feature vector is based on the feature vectors of the pixels in the road image samples labeled as lane lines by the lane line labels and the feature vectors of pixels adjacent thereto.

4. The method according to claim 1, wherein the lane line feature vector is based on a feature map output from an intermediate layer of the image segmentation model when the road image sample is input.

5. The method according to claim 4, wherein extracting the lane line feature vector of the road image sample comprises: adjusting the dimension of the road image sample according to the dimension of the feature map output from the intermediate layer of the image segmentation model.

6. The method according to claim 4, wherein the image segmentation model is a Segment Anything Model (SAM), and the intermediate layer is the penultimate layer of the SAM, the last layer of an image encoder in the SAM, or the last layer of a mask decoder in the SAM.

7. The method according to claim 1, wherein determining the lane line detection difficulty of the road image sample comprises:
fitting the lane line feature vectors of the plurality of road image samples in the dataset to a multivariate Gaussian distribution; and
calculating the Mahalanobis distance of the road image sample according to the multivariate Gaussian distribution, wherein the Mahalanobis distance is used to measure the lane line detection difficulty of the road image sample.

8. The method according to claim 7, wherein the Mahalanobis distance is the Mahalanobis distance between the lane line feature vector of the road image sample and the mean of the multivariate Gaussian distribution.

9. The method according to claim 1, wherein the loss function comprises an entropy regularization term having a weighting coefficient proportional to the lane line detection difficulty of the road image sample.

10. The method according to claim 9, wherein the entropy regularization term further comprises a global weighting coefficient for controlling the strength of the entropy regularization term in the loss function.

11. An apparatus for training a lane line detection model, comprising:
a memory; and
at least one processor, the at least one processor being coupled to the memory and configured to execute the method according to claim 1.

12. A computer program product for training a lane line detection model, comprising computer program code executable by a processor, the computer program code being configured to execute the method according to claim 1.

13. A method for detecting lane lines, comprising:
receiving a road image; and
detecting lane lines in the road image by way of a lane line detection model, wherein the lane line detection model is trained according to the method of claim 1.

14. An apparatus for detecting lane lines, comprising:
a memory; and
at least one processor, the at least one processor being coupled to the memory and configured to execute the method according to claim 13.

15. A computer program product for detecting lane lines, comprising computer program code executable by a processor, the computer program code being configured to execute the method according to claim 13.
